(19) United States
(12) Patent Application Publication
(10) Pub. No.: US 2018/0339719 A1
(43) Pub. Date: Nov. 29, 2018

(54) LOCOMOTIVE DECISION SUPPORT ARCHITECTURE AND CONTROL SYSTEM INTERFACE AGGREGATING MULTIPLE DISPARATE DATASETS

(71) Applicant: William Joseph Loughlin, Sudbury, FL (US)

(72) Inventor: William Joseph Loughlin, Sudbury, FL (US)

(21) Appl. No.: 15/987,973

(22) Filed: May 24, 2018

Related U.S. Application Data
(60) Provisional application No. 62/510,520, filed on May 24, 2017.

(51) Int. Cl. B61L 3/00; B61L 15/00; B61L 25/02; B61L 23/04; G06N 3/02

(52) U.S. Cl. CPC B61L 3/006; B61L 15/0081; B61L 15/0072; G06N 3/02; B61L 25/025; B61L 23/041; B61L 23/042; B61L 15/009

(57) ABSTRACT

A locomotive decision support architecture and control system interface aggregating multiple disparate datasets. Locomotive operators suffer from extremely high stress levels due to the tremendous responsibilities of their jobs. They are responsible not only for safely delivering cargo along with rolling stock, but also for the safety of the populations and the environment they travel through, all while trying to maintain a schedule and maximize profits for the company. The systems, methods, and apparatus is designed to provide an enhanced visibility of the operating environment and decision support tools to enable the operator to react to emergent conditions.

### CROSS-REFERENCE TO RELATED APPLICATION

This application claims the benefit of priority of U.S. provisional application No. 62,510,520, filed May 24, 2017, the contents of which are herein incorporated by reference.

### BACKGROUND OF THE INVENTION

The present invention relates to railroad locomotives, and more particularly to decision support systems and control interfaces for locomotives.

Locomotive operators suffer from extremely high stress levels due to the tremendous responsibilities of their jobs. They are responsible not only for safely delivering millions of dollars of customers' cargo along with equally millions of dollars of the companies rolling stock, but also for the safety of the populations and the environment they travel through (protecting the company from legal risk and financial loss). All while trying to maintain a schedule and maximize profits for the company. This invention will reduce those stress levels and increase safety and efficiency/productivity.

Positive Train Control (PTC), is a US Government-mandated program for train tracking and emergency/remote/automatic control. This federal mandate calls for compliance with the directive by December 2018 (inclusive of trains entering/exiting North America from or to Mexico and Canada). The PTC mandate includes communications and control specifications to be able to control the speed and stopping of a train based on situational elements of their surrounding environments (speed, maintenance work in area, grade, obstruction, etc.). It is estimated that when complete, it will impact over 70,000 miles of track and approximately 20,000 locomotives.

Current deployment models of Positive Train Control (PTC), which is a US Government-mandated program for train tracking and emergency/remote/automatic control are still relatively proprietary—that is, a railroad (i.e. Burlington Northern Santa Fe (BNSF) and Union Pacific (UP)), will deploy and maintain their own system/physical hardware infrastructure—including system data and processing/communications. The systems and methods of deployment vary from company to company.

Trans-continental freight/passenger operations, by definition, transit vast areas and multiple state/local/private jurisdictions (including using track belonging to other railroad companies). All the while their operations are governed by US DOT/FRA rules and requirements. With current systems, the availability of data can be inconsistent and of variable quality/accuracy. The train operator needs a consistent (common) environment that they can count on. The government sets minimums for compliance of PTC and what additional information is maintained is solely up to the individual operators (based on their resources and desire) so “user experience” and efficacy will vary from system to system.

Trains are unable to stop quickly or swerve. The average freight train is about 1 to 1¼ miles in length (90 to 120 rail cars). When it's moving at 55 miles an hour, it can take a mile or more to stop after the locomotive engineer fully applies the emergency brake. An 8-car passenger train moving at 80 miles an hour needs about a mile to stop. How does this compare to other vehicles?

According to the National Safety Council, a lightweight passenger car traveling at 55 miles an hour can stop in about 200 feet in an emergency—under perfect conditions—that is, if tires and brakes are in good condition and the road is dry. A commercial van or bus will need about 230 feet to stop. A commercial truck/trailer can stop in about 300 feet—that's the length of a football field. A light rail train requires about 600 feet to stop—the length of two football fields.

Compared to these, the average freight train we mentioned above traveling at 55 miles an hour may take the length of about 18 football fields to stop. Trains are unable to swerve—they can only follow the track. The only thing the engineer can do to avoid a collision is apply the emergency brake.

Freight trains can regularly travel at speeds between 60 and 75 mph. At those speeds, they are covering between 88 and 110 ft./sec. Given the above, a train moving at 75 mph and requiring 1.25+ miles to stop would take in excess of a full minute of braking to accomplish that. So in many cases, today, acceptable operator visibility would be nearly 1.5 miles and be able to identify obstacles clearly at that distance and be able to react. Without meaningful information regarding conditions ahead, and the condition of the locomotive, the locomotive operator's ability to respond to emergent conditions remains limited.

As can be seen, there is a need for an improved locomotive decision support architecture and control system interface aggregating multiple disparate datasets to allow individual locomotive operators to dramatically increase their scope and range of information awareness and control.

### SUMMARY OF THE INVENTION

In one aspect of the present invention, a locomotive control system is disclosed. The locomotive control system includes a detection component, having a plurality of sensors configured to determine an operating condition for a plurality of locomotive operating systems. The detection component also includes one or more forward looking imaging systems oriented to capture a live field of view along a track carrying the locomotive. A global positioning system (GPS) determines a current position of the locomotive on the track. A geospatial information system providing geographic information for a designated track infrastructure to carry the locomotive. The detection component providing an input layer to a neural network. A locomotive manager is configured to provide automated real time control inputs to the plurality of locomotive operating systems. The automated real time control inputs are responsive to an output of the neural network.

In some embodiments, the detection component may also include a rail integrity monitoring system providing an integrity condition of the track in advance of the locomotive along the predetermined course. The detection may also include a crossing guard component, having one or more cameras providing a live image of a crossing grade for the designated track infrastructure. The detection component may also include one or more of an engine health sensor; a turbo health senor; and a combined health sensor. In other embodiments, a car integrity monitoring system determines an operational status of one or more rail cars carried by the locomotive.

The system may also include a display system to selectably display a plurality of viewing regions, wherein a selected information feed may be displayed within each of the plurality of viewing regions. One of the plurality of viewing region may include a synthesized view of the track ahead of the locomotive provided by one or more imaging systems. Another viewing region may present a positive train control (PTC) information display. In yet other embodiments, one of the plurality of viewing region is a live video feed of a crossing grade along the designated track.

Another of the plurality of viewing region may include an alert of an abnormal operating condition detected in one of the plurality of the locomotive operating systems, wherein the alert includes a visual representation of the operating system and an indicator for an affected component. Preferably, in a companion viewing region, a live video feed of an area corresponding to the affected operating system. The alert and the companion viewing region are autonomously presented upon detection of the abnormal operating condition.

In other aspects of the invention, a digital locomotive cab, is disclosed. The digital locomotive cab includes a mobile computing device operatively connected to a communications network of the locomotive. The mobile computing device is mounted to receive a touch screen input of an operator seated at an operator's seat of the locomotive cab. A heads up display system (HUD) is configured to selectably project, on a windshield of the locomotive cab, a visual representation of: one or more operational parameters of the locomotive, an environmental condition of the exterior of the locomotive, and an augmented reality representation of a track carrying the locomotive; the visual representation discernable from the operator's seat of the locomotive cab. The visual representation may include a forward looking infra-red (FLIR) image of the track ahead of the locomotive. The visual representation may also include a radar image of the track ahead of the locomotive. In some embodiments, the visual representation includes a route designation indicia representing a course of the track ahead of the locomotive. Alternatively, the visual may include a prerecorded video image of the track ahead of the locomotive, corresponding to a current location of the locomotive on the track.

In yet other embodiment of the locomotive cab, a digital assistant is operatively connected to the communications network, the digital assistant responsive to voice commands of the operator. The digital assistant may provide one or more of: an audio alert of an operating condition of the locomotive, a waypoint announcement; and a communication of a track hazard. The digital assistant may also provide an audio communication channel with an operations center.

These and other features, aspects and advantages of the present invention will become better understood with reference to the following drawings, description and claims.

### BRIEF DESCRIPTION OF THE DRAWINGS

FIG. 1 illustrates a representative deep neural network to implement aspects of the locomotive decision support architecture and control system of the present invention.

FIGS. 2a and 2b illustrate a system architecture for the locomotive decision support architecture and control system interface.

FIG. 3 illustrates a conventional locomotive control cab.

FIG. 4 illustrates locomotive control cab employing aspects of the locomotive decision support architecture and control system interface.

FIG. 5 illustrates an isolated view of the windshield with heads up display (HUD).

FIG. 6 illustrates a first configurable user interface (UI) for a locomotive control system.

FIG. 7 illustrates a second configurable UI for a locomotive control system.

FIG. 8. illustrates a third configurable UI for a locomotive control system.

FIG. 9 illustrates a detailed view of a LookingGlass UI for a locomotive control system.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiments of the present invention provides a system, method and apparatus for a Locomotive Operation Decision Support Architecture and a Control System Interface. The system includes a neural network to monitor and process multiple existing and available data sets, products and technologies that, through systems integration, results in a robust locomotive operator interface and decision support environment.

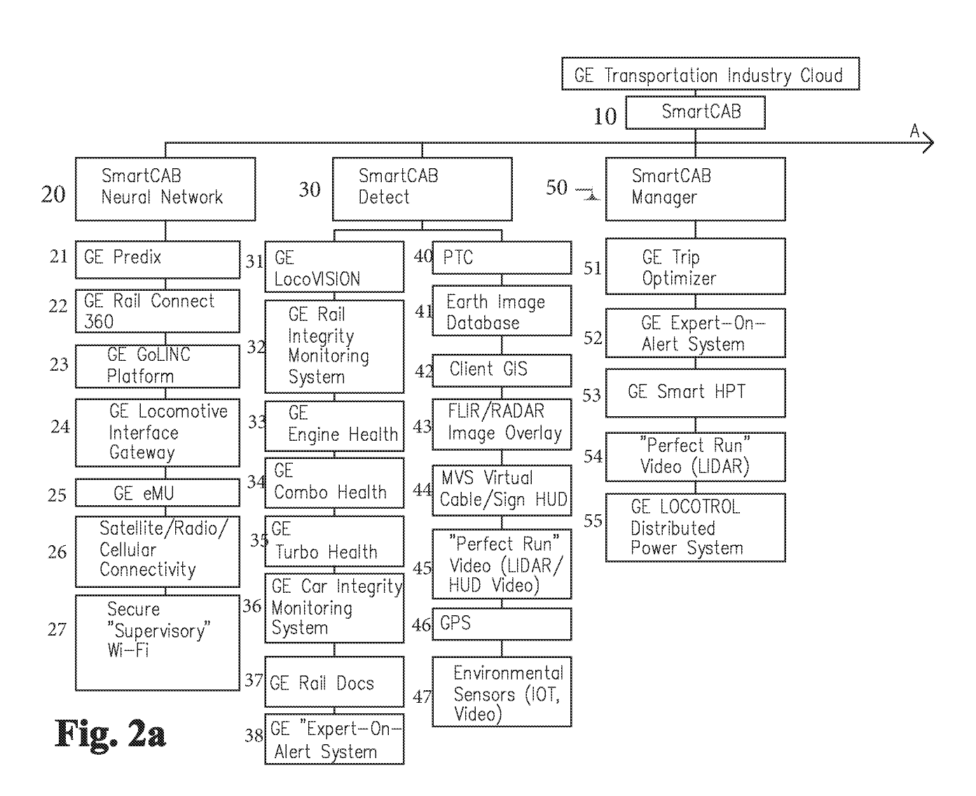

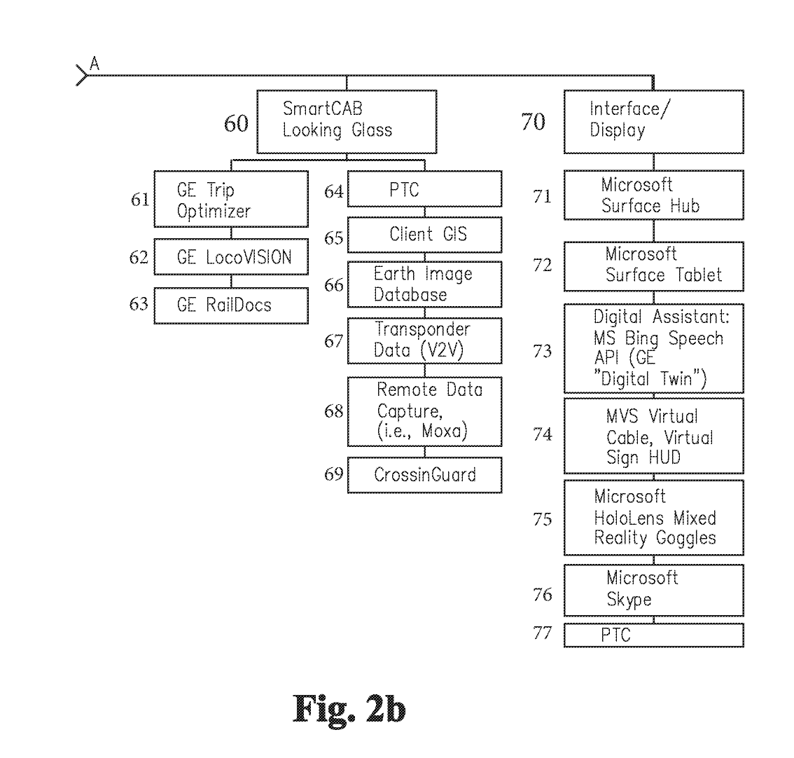

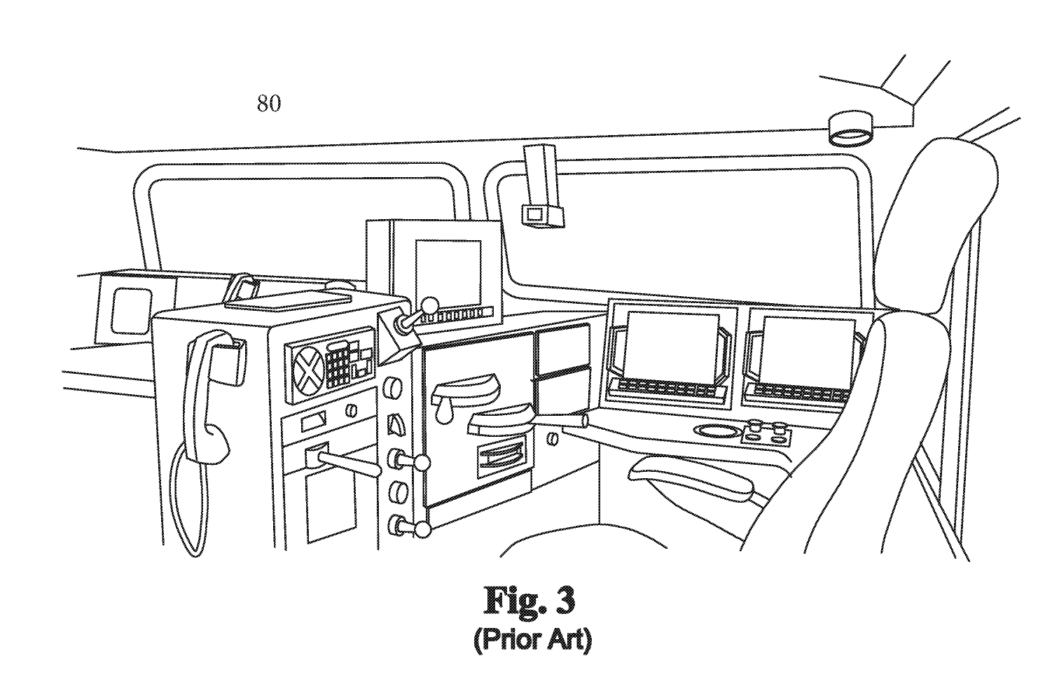

A representative system architecture is shown in reference to FIG. 2, which serves as a framework and interface for the integration of both on-board and external assets. The umbrella system environment is identified as “SmartCAB” 10. It has individual supporting components that contribute their own discrete value to the decision support system. The current SmartCAB architecture 10 may include: a SmartCAB Neural Network 20, a SmartCAB Detect component 30, SmartCAB Manager component 50, a SmartCAB LookingGlass component 60, and in interface and display component 70.

### The SmartCAB Neural Network:

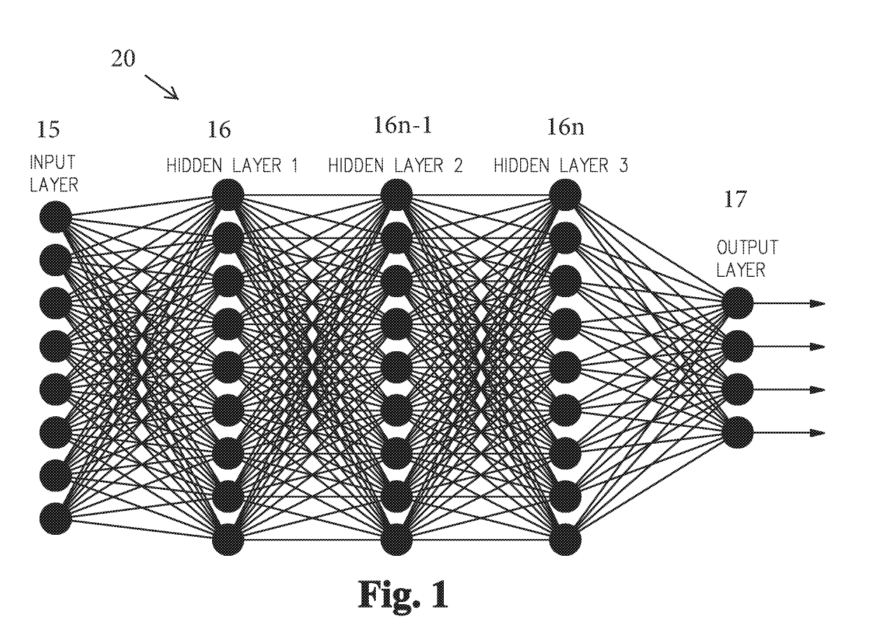

The SmartCAB Neural Network 20, is represented in reference to FIG. 1. In the SmartCAB Neural Network 20, every cell is aware of every other cell. Every cell knows and talks to every other cell and exchanges thousands of bits of information per second. The neural network 20 includes an input layer 15, one or more hidden layers 16, and an output layer 17. This neural network 20 represents the locomotives central nervous system—its neural network (Internal and External) as well as its lifeline to the outside world. It provides the secure infrastructure and data store that feeds all of the other services and components. The SmartCAB Neural Network 20 may be implemented with a standard base/core infrastructure platform 21. By way of non-limiting example it may include a General Electric (GE) Predix 21, a GE Rail Connect 360 platform 22; a GE GoLINC platform 23, a GE Locomotive Interface Gateway 24, a GE eMU 25, and a communication suite 26, including satellite, radio, and cellular connectivity. It may also include a secure supervisory WiFi 27. The neural network 20 may also include a plurality of sensors (IoT), both internal and external, to measure, relay/communicate and feed the other functions. These elements are streamlined to provide a seamless information backbone. External compatibilities required may include the US DOT/FRA Positive Train Control standard (PTC) and Application Programming Interfaces (APIs) to rail operator and other databases/data sources.

### SmartCAB Detect:

SmartCAB Detect 30 may include any and all elements of the IoT (Internet of Things) that detect/record/send data in relation to the locomotive (either onboard, off board, or a combination of the two). These may include V2V (Vehicle to Vehicle) communications/identification (voice/data exchange, “Hyper-Transponders”). These are not necessarily separate components and the system contemplates, that there may be sensors on every moving and critical component of a locomotive/train configuration providing inputs 15 to the neural network 20. The system aggregates the output of these devices to enable all involved (operations center as well as the on-board operator to be able to make quick, confident decisions regarding the function and operation of the train unit.

By way of non-limiting example these may include of the GE products initially aligned with this function along with additional industry and private data sources which may also be implemented for integration. This may include a locomotive vision component 31, such as a GE LocoVISION. A Rail Integrity Monitor System 32, an Engine Health component 33, a Combined Health component 34, a Turbo Health component 35, a Car Integrity Monitor System 36, a GE rail Docs component 37, and an Expert-on-Alert System 38,

The SmartCAB Detect 30 may also include a US DOT/FRA positive train control (PTC) component 40, an earth image database 41, a client Geospatial Imaging System (GIS) 42, a forward looking imaging system, which may include conventional optics, infrared or radar image overlay component 43; a route designation component 44, such as MVS virtual cable and signage heads up display component 44; a “Perfect Run” Video (LIDAR/HUD Video) component 45, such as a Burlington Northern Santa Fe (BNSF); BNSF LIDAR/GIS System; a global positioning system (GPS) component 46; and one or more environmental sensors 47.

### SmartCAB Manager:

The SmartCAB Manager 50 represents the system capabilities that actually make changes to the locomotive system—including but not limited to speed, braking, taking elements off-line, etc. The SmartCAB Manager 50 may include: a trip optimizer component 51; an Expert-OnAlert System 52; a horsepower per ton component 53; a Perfect Run Video (LIDAR) 54, and a GE LOCOTROL Distributed Power system 55.

With the SmartCAB Manager 50, the GE Trip Optimizer 51 is enabled to become even more of a Master Command/Control and Interface System. Optimization is only one aspect of control and would be a subsystem to the SmartCAB Control 10 umbrella. Through the SmartCAB Manager 50, the trip optimizer, such as GE's Trip Optimizer 51 may operate in a real-time cruise-control fashion for regular operations, as well as in conjunction with PTC 40-to manage speeds and any required automatic braking. Additional input from transponders, crossings, switches and signals will continue to add to its database and elements of Artificial Intelligence (AI) and machine-learning through the neural Network 20, to make it an ever-smarter system, harnessing the value individual locomotive experiences to better the collective experience, efficiency, and safety of railroad operations.

### SmartCAB Manager:

The SmartCAB Manager 50 provides is an improvement to GE's current HPT offering. Within SmartCAB Manager 50, the GE Trip Optimizer 51 looks forward along the planned route, and based on the slope of the route ahead (i.e. incline or decline), plans for areas where some of the total number of locomotive's power is not needed and idles one or more of them utilizing either Train Lines or the eMU resulting in incremental fuel savings. However, an enhanced “Smart HPT” would also be able to determine to idle or shut down one or more engines or traction motors if the SmartCAB Detect systems report a subsystem problem. Thus, it would not be limited to only flashing a warning light that there was an engine/turbo/cooling system/etc. problem and leave it to the operator take on the decision of what needed to be done. Nor would it need to wait for the Expert-on-Alert system to sort the issue and drive the decision. Rather it could implement automatic controls that, by way of non-limiting example, could idle the affected unit and allow the train to proceed at a reduced power condition.

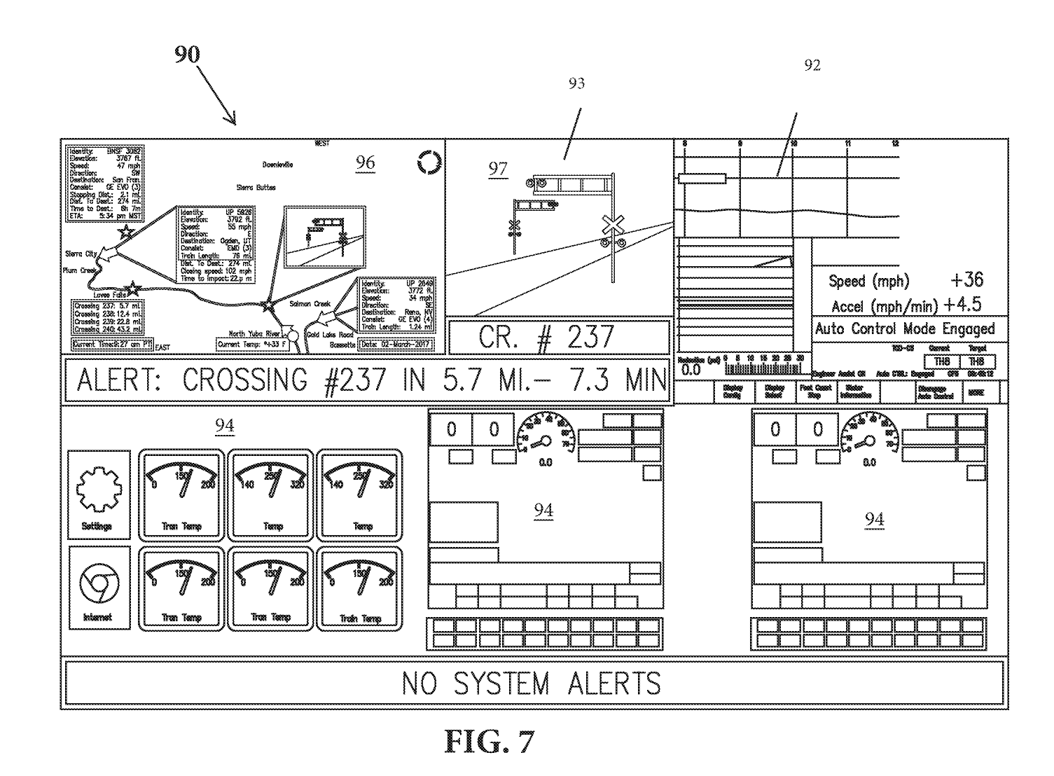

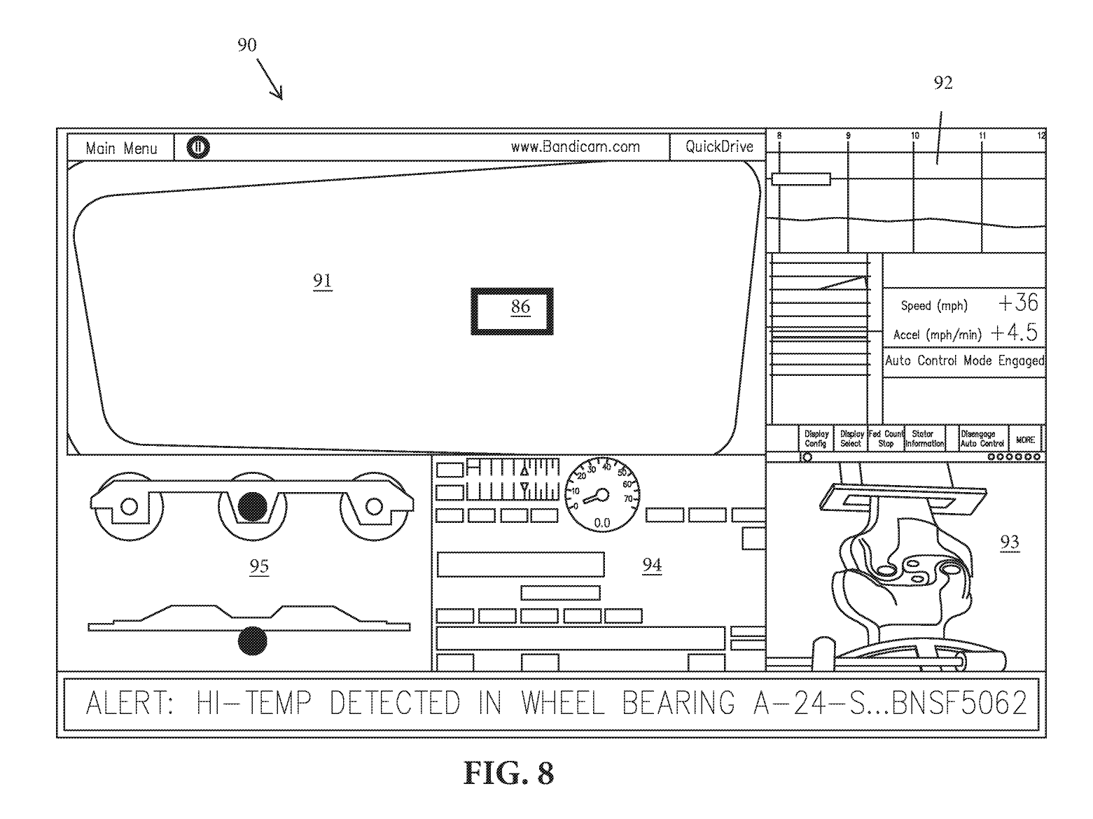

SmartCAB LookingGlass—“Your eyes in the sky.” (FIGS. 7, 8):

The SmartCAB LookingGlass 60 integrates a number of separate components, including a Trip Optimizer component 61; a video capture component 62, such as GE LocoVISION; and a track maintenance component 64, such as GE RailDocs. In addition to the foregoing, the SmartCAB LookingGlass 60 includes an interface to the SmartCAB Detect 30 subsystems including: the PTC component 64; client GIS 65, Earth image database 66, a remote data capture 68; and a CrossingGuard component 69. With an improved real-time capabilities LocoVISION, is enabled to become a primary operator interface (their improved eyes), while SmartCAB LookingGlass 60 provides an advanced route planning/intelligence interface that also operates in real-time, however, it presents the operator a broader range of visibility. LocoVISION 65 presents a current view, while LookingGlass 60, presents an “over the horizon view” of what will be occurring next around the corner, or later in the trip that the operator will encounter. With SmartCAB LookingGlass 60, the operator is provided with a navigation system view of their route, which may be presented as a 3D perspective view, with significant points of interest showing up on the route, such as MVS Virtual Sign 44, and company/network GIS data, such as RR crossings, switches (either used or unused) etc.

Leveraging information that already exists in Trip Optimizer 61 and PTC 64, combined with earth/route visualization capabilities found in satellite and GIS systems 65, SmartCAB LookingGlass 60 becomes the master route monitoring and interface system for the operator. A dedicated drone may also be incorporated to fly in advance of the route and download real-time video of the track ahead, providing the operator the ability to see around corners.

### Interface/Display

The Interface/display 70 within the system is multi-dimensional. It can be provided via a touchscreen on the large screen monitors 72, via a hand-held tablet “remote”, via one or more heads up displays 74 projected on a windshield 83 of the locomotive, via a set of Virtual Reality/Augmented Reality Glasses 75, and/or by leveraging voice control digital assistant technology 73, such as Cortana, by Microsoft Corp. to orchestrate the required interactions. Due to the harsh operating conditions within the locomotive cab (high noise levels), it would also be desirable to utilize a unique headset for the engineer and the conductor that would incorporate a number of interface elements: audio headphones, microphone, with noise cancellation capabilities. The interface can include a deployable (flip down) VR/AR reticle/goggles/lenses or a high-quality sun visor (like those incorporated within military pilot's helmets).

With VR/AR devices, there has been a good deal of debate regarding; what, or how much technology to incorporate in them. It is usually based on whether they are used in a dedicated location/purpose, or for mobility, requiring a wireless and battery-powered experience. Since the prime use is normally confined to the locomotive cab 80, the headgear may be tethered with both power and signal hard-wiring, thereby eliminating the need for heavy batteries or relying on Bluetooth for communications. More of the device could be dedicated to processing vs. power, for richer functionality. If the operator needed added mobility, they could use a wireless headgear, configured for communication with the system.

### Enhanced Digital Locomotive Cab

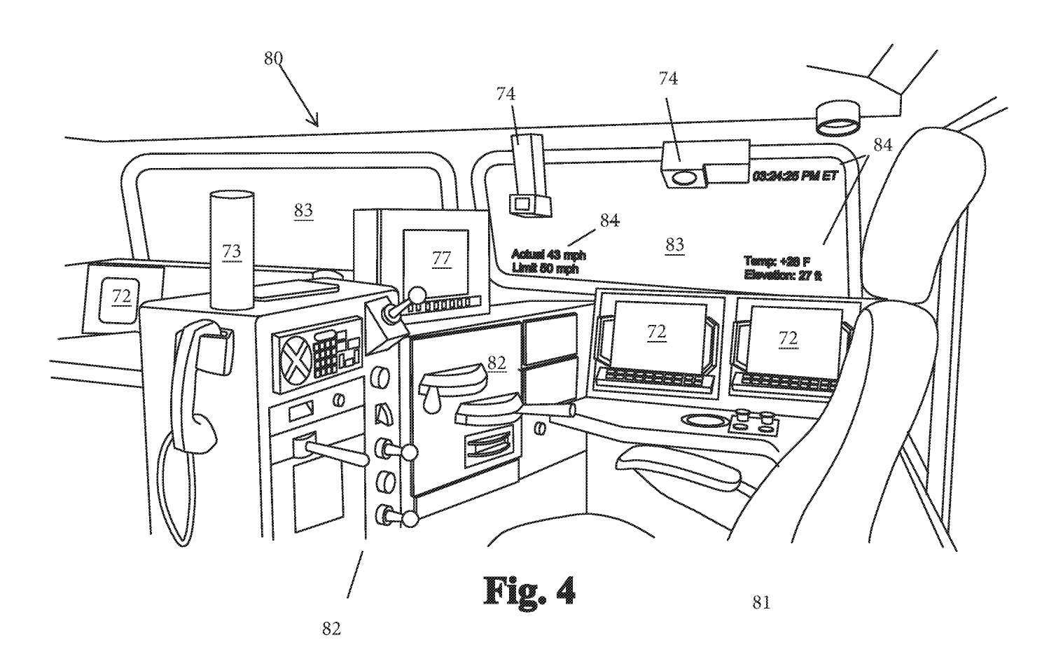

A representation of an enhanced digital locomotive cab 80 may be seen in reference to FIG. 4. The cab 80 includes an operator's seat 81 providing access to a plurality of conventional locomotive controls 82: The digital locomotive cab 80 according to aspects of the invention includes a variety of interface and display systems accessible or immediately viewable from the operator's seat 81. The interface and display system may include one or more portable computing devices 72, preferably with a touch screen user interface, such as a Surface Tablet, from Microsoft Corp. The portable computing device 72, may also include a hub (not shown) to operatively connect the one or more computing devices 72 to the SmartCAB system 10. The portable computing devices 72 include a configurable display user interface 90 to display various system, navigational, and other parameters for the operator to view. The digital cab 80 may also be configured with a digital assistant 73 that is responsive to voice commands of the locomotive operator. The enhanced digital locomotive cab 80 may also be configured with one or more heads up display systems projected onto the surface of one or more of the locomotive operator's front windshields 83. As indicated, optionally, the HUD information may also be viewable on augmented reality glasses, a reticle, and the like.

LocoVISION 2.0 with Enhanced HUD (Heads up Display)

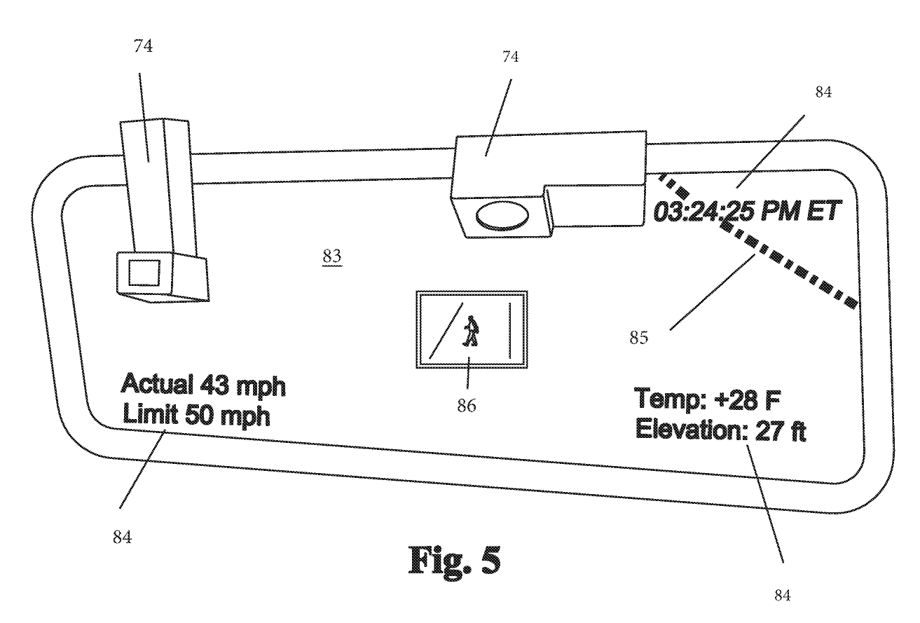

As seen in reference to FIGS. 4 and 5, HUD information may be selectively presented on the operator's front windscreen 83: The projected HUD images/information may include: a route projection indicator 85, such as that provided in Virtual Cable, by MVS, of San Jose, Calif. The route projection indicator 85 may include a line, typically red, that is projected in the window 83 that provides a view of the projected course of the track in advance of the train, to give a visual indication of the path the train will be headed. The digital path 85 is projected so that, in this case, the operator can “see” beyond any visibility limits through the windshield 83, such as fog, to know that the train is approaching a sweeping bend in the track and not a continued straight route. The route projection indicator 85 may also include a Virtual Signage component, which can project traffic/wayside signs or other important asset locations and be virtually inserted onto the windshield 83.

As seen in further reference to FIG. 5, the enhanced LocoVISION system the projected HUD images/information may include a plurality of user selectable information sources including: operational and performance parameters 84, including, but not limited to time; speed, operational limits; environmental variables, such as temperature, elevation.

The HUD projection may also include a FLIR/RADAR, or other visual imaging 86 of the route in advance of the locomotive along the track that may be projected towards the center of the windscreen 83, which may be occupied by one or more video feeds or combined feeds from the FLIR/RADAR systems 43, 45 (and/or “super-telephoto” lens of LocoVISION 2.0, until an anomaly is detected—then replaced by the electronic image).

### Lower “Large Format” Configurable Display:

Referring back to the cab view of FIG. 4, the digital cab 80 further includes mobile computing device display(s) 72 that provide a focal point for a plurality of selectable information feeds, via a UI 90, including both operator selectable information feeds as well as those feeds that may be autonomously selectable, or automatically “promoted” by the system to alert the operator to an emerging condition.

On top of the center control cluster sits the PTC Operator Control Panel 77, which is maintained for reference purposes, and regulations that may require it to remain as a stand-alone system. The PTC operator control panel 77 functions may also be incorporated into one of the plurality of selectable information feeds within the within the Surface Hub Display UI 90.

Further left on top of the center control console 82 is a representation a digital assistant 73, such as the Predix Digital Assistant. Voice controls may be built on top of GE's Digital Twin program. Digital Twin will also work with Microsoft's HoloLens mixed-reality goggles, allowing someone to step into a 3D image of the equipment. All primary communications may be handled through the digital assistant 73. Due to the operating conditions within the locomotive cab (high noise levels), it would also be desirable to utilize a unique headset for the engineer and the conductor that would incorporate a number of interface elements: audio headphones, microphone, deployable (flip down) VR/AR reticle/goggles/lenses or just high-quality sun visor (like those incorporated within military pilot's helmets). Since this use is primarily confined to the locomotive cab, the headgear may be tethered with both power and signal hard-wired, eliminating the need for heavy batteries or relying on Bluetooth for communications. More of the device could be dedicated to processing vs. power for richer functionality. If the operator needed added mobility, they could use standard issue radios, or a wirelessly connected headgear for temporary situations.

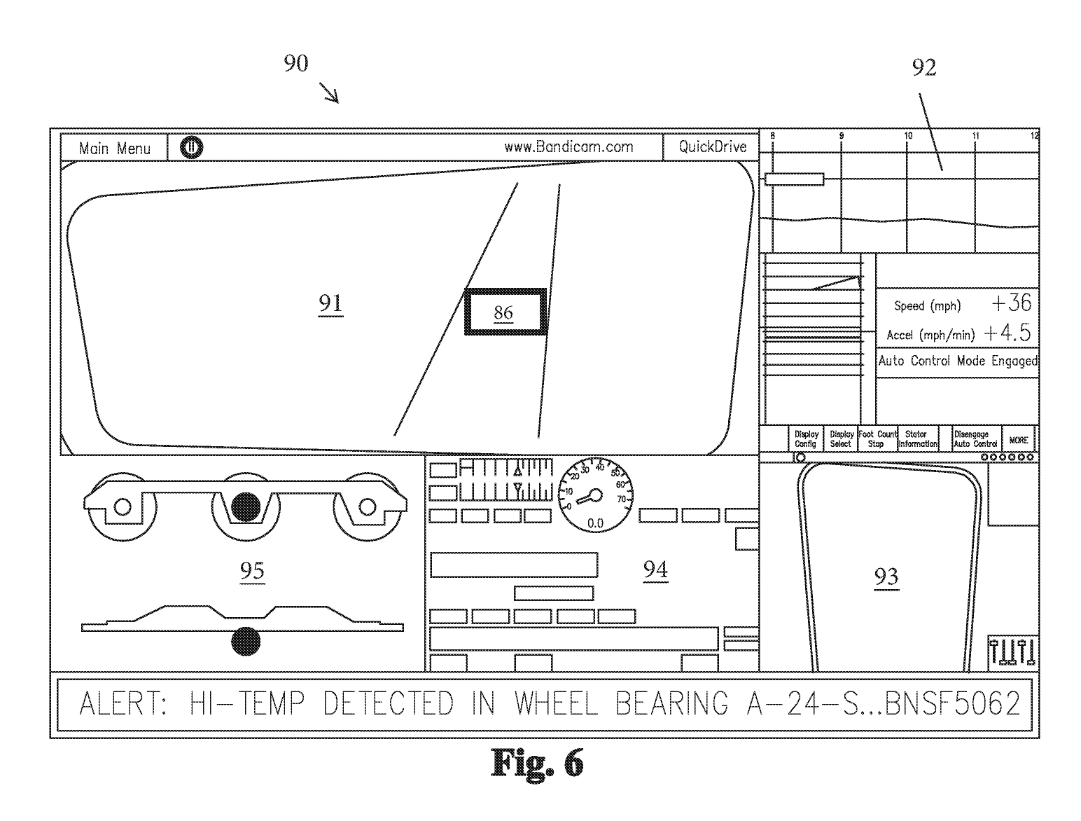

Left Side of Cab: Conductor position. For redundancy, the conductor position may be configured to use a different source of HUD (Heads up display) technology to offer additional/supplemental data for the safe operation of the train. This would provide a different level/source of data to the conductor which would serve as a “fail-safe” design. The Conductor and Engineer would therefore, not both be relying on the same technology in order to govern operations of the train. By way of example, the Conductor's HUD may present an augmented/virtual representation of the track ahead, such as shown below in reference to FIG. 6.

### Configurable User Interface

The configurable user interface 90 would be a focal point for selectable information feeds (both operator selectable as well as autonomously selectable (automatically “promoted” by the system)).

As seen in reference to FIGS. 6-8, a configurable user interface 90 may incorporate a plurality of selectable viewable regions. For example, in a first region the HUD system 74 and video imaging systems may also provide a synthesized view of the track ahead 91 on the display of the one or more computing devices 72. The first region 91 may represents “Perfect Run” content to represent what the area around the train “should” look like at that point in time, which may consist of video segments of the actual route that have been captured over time either by specific data capture vehicles or by LIDAR systems mounted on regular locomotives—updating the situational information as frequently as possible/necessary. Segments can be “knitted” together to deliver the exact route for that train from an archive of all of the route segments for the railroad. This would be valuable in situations where visibility through the windscreen is either poor or negatively impacted in some way (blizzard, fog, sand storm, heavy rain, night time, etc.). The system 10 could also provide a “zoom” function of the HD camera as well as overlaying FLIR or RADAR input. Thus, even if conditions obscure the operator's vision out the window 83, such as during night operations, snow, rain, smoke, dust and fog conditions, the synthesized view of the track 91 may provide the locomotive operator a live enhanced view of the track and conditions. Accordingly, the system is able to transform current video imaging systems, which are largely archival in nature, into a pro-active video of the track conditions ahead. Thus, the video feeds are presented and used in operations, not just stored for an after the fact archive to explain how a collision happened, or to preserve video evidence for after the crash (like aircraft black boxes—it's too late then). Ideally, under the current system, the video feeds may prevent accidents from happening in the first place. The availability of the synthesized view of the track ahead also provides the operator with a view of the track while they may be involved in monitoring operating conditions of the train and accompanying tasks as they are engaged with the computing device 72.

Other familiar navigation feedback 93 may also be available in another selectable region 92. In this example, the upper right represents the PTC Locomotive Engineers Display. It would comply with DOT/FRA requirements for content. Due to regulations, this portion of the larger display may have to be “pinned” permanently with this content.

The configurable user interface 90 may also include a viewing region for the presentation of a selectable video feed 93 viewing one or more locations throughout the train. The feed may selectively loop through a plurality of locations, or may be selectable by the operator to monitor a specific location. The system 10 may also autonomously select the desired video feed based on detection of an abnormal or emergent condition that may be monitored by a selected video feed to provide the operator greater situational awareness of the emergent condition.

Another selectable viewing region Lower row of the display contains train operational information 94, which may include selectable status gauges. The display can have “soft buttons” to change the display functions, as well as being controlled by the operators' tablet.

An alert viewing region 95 may also be provided. The alert viewing region may provide a graphical depiction of a component or subsystem which has indicated an anomaly. By way of non-limiting example, the alert viewing region 95 may promote itself indicating a hi-temp condition on one of the combo wheel bearings. The alert viewing region 95 leverages the actual combo drawings that it retrieved to identify exact location). This is also communicated in the text alert strip along the bottom of the display (colors changing to Yellow and Red with the exact component identification number), as well as calling up the video feed (lower right) from the appropriate onboard camera to show that the bearing is actually on fire. These additional levels of information would allow the operator (or the system itself) to determine the best course of action (i.e. initiate/allow automatic fire suppression (if available) or to initiate a stoppage of the train in order to extinguish the flames manually). It also provides time to communicate with the operations center and the rest of the crew in order to develop a safe plan of action to resolve the situation (although the ops center would have also received the same alerts).

Locomotive performance data 94 may be presented in one or more other selectable viewing regions, such as shown in FIG. 8. The operator can also select a route guidance system 96, such as the LookingGlass. With the augmented capabilities of the system 10, selection of an upcoming crossing presents a live feed 97 from one or more cameras covering the selected crossing (via IP) (i.e. as in CrossingGUARD). The user can also select a switch along their route to assure themselves that it is in the open or closed position via status, it may also be pre-marked on screen such as in Green or Red to indicate a switch status. For example, it may initially be Red for another train to change route, but after that event, it should be changed to Green on this trains route package. In some embodiments, an IPTV feed showing the actual switch to enable seeing the actual position of the switch arm. Switching may be one of either manual on the ground or remote activation from an ops center.

The digital assistant 77 may also provide voice notification of upcoming events (like “RR crossing #X in 10 miles”, congested area, accident/system warning, entering maintenance area, significant grade change, significant speed change (either higher or lower), dangerous curve, overhead clearance alert, proximity to other train, etc.

In this case, the video feed region 93 is populated with an image from the “CouplingCAM”. This can be selected during a hookup process and also ad hoc during a run if the operator has any concerns. It may also be set to automatically open when the locomotive is put into reverse (as in automobiles with backup cameras). The CouplingCAM also doesn't require any crew to physically put themselves into harm's way in order to inspect the integrity of the coupling, day or night.

SmartCAB LookingGlass with CrossinGUARD:

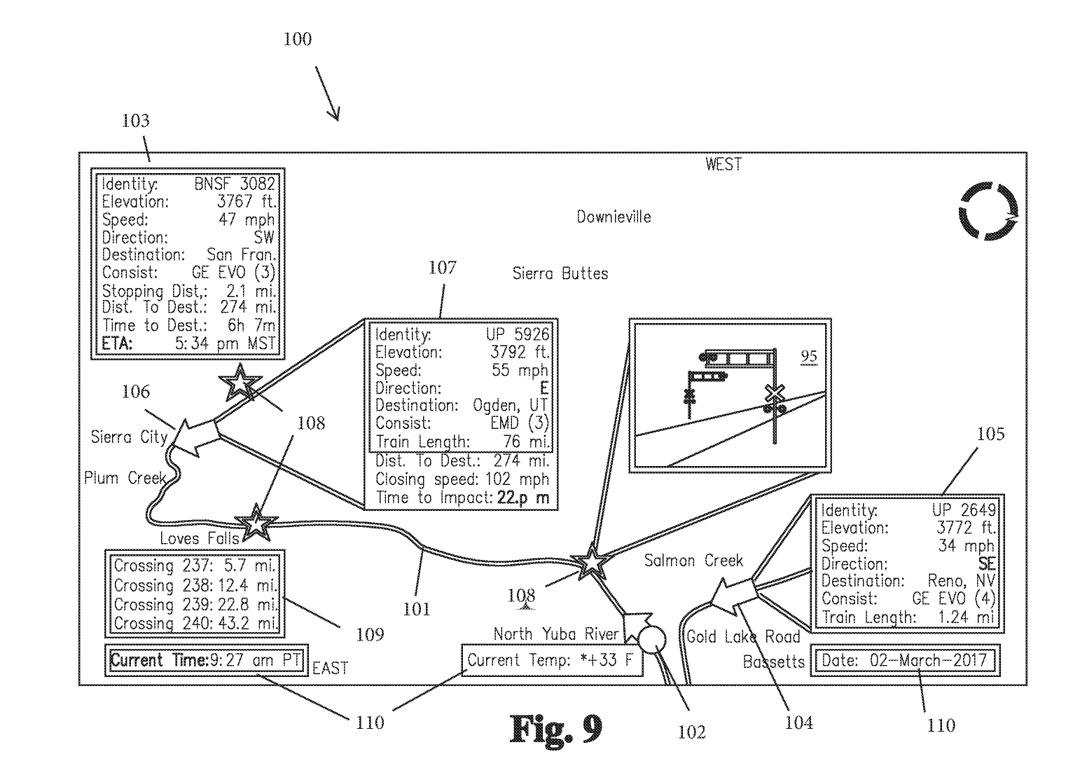

FIG. 9 features a detail view of the LookingGlass module, including the CrossinGUARD capability (center image). Note the alert text strips and the promoted view 95 of the upcoming crossing—the system has full knowledge of all details related to the crossing as well as the trains geo-relational context to it, and “pushes” this information in a timely manner without operator action.

Enhanced situational awareness is provided by a unified version of the path ahead—blending GPS, LiDAR, remote monitors (crossing video, switch disposition). SmartCAB LookingGlass allows the operator to visualize the projected route, including data from central dispatch that has switch status, other assets using a track, a blend of real-time video with the ability to overlay FLIR during night and severe weather, and recorded video of perfect track conditions and have the neural network 20 look for anomalies, by detection of disparities where a current situation does not match “normal” condition.

In the example provided, the computer knows from the weight of the train and the speed, along with locational information (i.e. is it going uphill, downhill, flat grade, turns) how long it will take to safely stop the train (for example, one can stop a train more aggressively on a straightaway vs. on a curve). This changes constantly. So the computer always has a new “safe distance” to operate under. When the system detects that there is an obstruction at a crossing, and it is about to enter the “CRASH” zone, it can autonomously initiate a safe stop procedure . . . without human intervention.

The same process may also be implemented, for example, if a track switch that is needed to be open for safe transfer to another track is still closed, the system 10 train can initiate a stop. Likewise, for a track obstruction: the system 10 can detect an object in the path. If train is going 60 mph and closing rate on the object is 60 mph, then the object is stopped. If closing rate is 120 mph, then computer knows it is another vehicle (either locomotive or track maintenance vehicle) approaching at it at 60 mph. In first case, the system 10 could initiate safe stop procedure. In second case, the system, or operations center, could remotely initiate stop procedure on the oncoming train as well.

The LookingGlass screen may also provide a 3-D perspective view of the route, augmented with GIS data, and may also alert the operator with points of interest along the way. A colored line 101 may be provided to show the upcoming route on the track. An indicator 102, such as a Green arrow with Red dot indicates the current train (an identification box 103 has the trains details), while other colored train indicators 104, such as arrows, represent another train on a separate track (with its own call-out detail box 105) (arrow 104 may be Green since it poses no danger to any other train). A Red train arrow 106 indicates yet another train (with its associated info box), however this one is on “our” track, and will lead to a collision. The train indicator 106 and info-frame 107 are Red also, indicating action should be taken to contact the other train and/or ops center immediately. The system may be configured to transmit a pre-recorded message that can be automatically initiated after a predetermined duration has passed since notification to operator—to assure maximum response time is allowed—example follows) (although ops center will be seeing same warnings), and also be able to initiate auto-stopping procedure after the predetermined temporal duration, assuming that the operator has not seen the problem or is in some way incapacitated. Transponder data is received identifying the unit and the meta data of its load/destination/and current status, and contact details and info including critical info such as distance, closing speed and time to impact.

### Sample Automated Radio Exchange:

Predix Digital Assistant (BNSF 3082): “This is BNSF 3082 hailing UP 5926, over.”

UP 5926: “This is UP 5926, over.”

BNSF 3082: “UP 5926, my systems inform me that we are on a collision course that will result in impact in 22.9 min. We are initiating an immediate controlled-stop. Request you do same. Repeat, request immediate initiation of controlled stop. Notifying operations of our actions, over.”

UP 5926: “acknowledge BNSF 3082—initiating controlled stop immediately, over.”

A grade crossing indicator 108, such as a star, represents grade crossings ahead on the route. A next grade crossing indicator 109, which may be colored yellow to indicate the next grade crossing and is still outside of our minimum safe stopping distance limit. The live video stream 95 from the crossing has automatically populated the screen prior to crossing into the area where we could no longer safely stop the train before intersecting the crossing. The operator can monitor the crossing right through safe passage, and once clear—the feed will stop automatically. When the train is outside the safe perimeter area, the operator can click or hover on any grade crossing indicator 108 to initiate viewing the associated live feed 95. CrossingGUARD details include IPTV broadcast of live crossing video “on-demand”.

Other options may include symbols for switches—showing Green or Red for open/closed. Tied into the “logic” for the train's designated route. The switches could also be queried (visually) to observe and confirm that they are in an open or closed condition. Much like other auto/computer map visualization applications, the amount/level and granularity of detail expands as one zooms in, and fade as one zooms out. Ops centers would have the same access to all of this information, but the key advantage is having it available in the cab 90.

A waypoints box 108 indicates upcoming waypoints along the designated route. In this example, the waypoints box 108 provides an identification of a specific grade crossings and the distance to them. Rolling screen adds the next waypoint once current waypoint is passed. Other indicators 110 may provide current time/time zone, date, and outside temperature—note that the temperature indicator may be color coded, as temperatures near or go below the freezing point—where track conditions may be hazardous.

This screen represents the integration of data elements/feeds from GIS, GPS, Trip Optimizer, RailDocs (Wayside Asset Management System) (crossing detail, switch information, etc.), transponder input (V2V), and possibly much more. [Voice notification of upcoming events (like “RR crossing #X in 10 miles”, congested area, accident/system warning, significant grade change (from Trip Optimizer), significant speed change (either higher or lower) (from TO), dangerous curve, restricted clearance alert, proximity to other train, low fuel (or distance to empty) etc.

Again, this is separate from the enhanced LocoVISION discussed earlier. SmartCAB LookingGlass is more of a route planning/intelligence interface (decision support). LocoVISION is NOW, and LookingGlass is “what's next, or later”, over the horizon . . . around the corner.

### SmartCAB CrossingGUARD:

The SmartCAB CrossingGuard component is based on the premise that no matter what preventative measures are placed at grade-level RR crossings, people manage to try to circumvent them and it ends in tragedy. High speed trains, hidden crossings due to terrain and/or vegetation, stopping distance, visibility/weather conditions all contribute to accidents. The CrossingGuard component 69 includes establishing a standard for real-time video surveillance/capture/broadcast to provide locomotives en-route to be able to see the real-time status of a crossing that they are approaching, in order to allow them to determine if they should initiate a stop or reduction in speed (over and above the commands and rules of PTC). This could also be “automated” by calculating the speed (and inertia) of the train along with distance to contact and safe stopping distance.

The CrossingGuard component 69 includes a plurality of cameras (IP) (HD, low light, IR, etc.) at different points/corners to provide accessible real time video of the crossing. While providing redundancy, the plurality of cameras would also be able to broadcast an image regardless of time of day or level of visibility (i.e. snow, rain, fog, darkness). These images would be fed into a local processor and then broadcast over secure IP address. As the locomotive enters the crossing zone (determined by speed and time it takes to stop the train), the system 10 would pick up the secured broadcast URL (IP) and be able to present the real-time crossing images 95 on their monitors 72. The video feed would also be sent over the internet to the operations center (continuously) that owns the line(s) utilizing the crossing. While the train or ops center could tap into the video feed at any time, each would be sent an alert whenever a locomotive (radiating a transponder signal) was entering the critical space. Operators on board could also open the link at any time via SmartCAB LookingGlass.

The CrossingGuard component 60 may also provide the capability to project an “electronic fence” that would trigger additional alerts, at which point, the operator or the automated system 10 could initiate emergency procedures as necessary. Once through the crossing the feed would automatically be dropped.

By using a data/video capture infrastructure, such as that from Moxa—moxa.com) as a basis for additional enhancements, the system may provide leverage/integration points with LocoVISION. Also, Collision alert at non-crossing/infrastructure locations, may be provided with enhanced LOCOVision 2.0.

Wayside Detection: The wayside is one of the highest risk zones of the rail infrastructure, and lack automated high-accuracy solutions. Remote wayside locations are difficult to access and tough to monitor, and thus present significant deployment challenges. Current systems can automatically detect several key wayside scenarios:

People entering the level-crossing at any time. Any moving object other than trains identified on the track. Objects abandoned at trackside. Large metallic or organic objects on the tracks such as logs, shopping carts, or a motorcycle. People crossing the railroad tracks.

The CrossingGuard component 60 provides the ability to broadcast these events to our targets within the working area of the crossing (i.e. —working area=distance required to bring any given consist to a full stop prior to entering the crossing zone). This working distance will differ from train to train given speed, number/weight of cars, total braking ability and operator or auto system response time. Normal situations may not trigger an event, and even this system will not stop all events (crossing is clear of normal traffic right up until the last second), however, this system would eliminate situation where there is an obstruction at the crossing that cannot be cleared (and the crossing gates may actually be or “show” closed), but that the train operator cannot see until it is too late to safely stop/slow the train (either due to weather, terrain, etc.).

By having the ability to get advanced warning of potential problem, trains could potentially operate at a higher speed through congested areas where they currently rely on pure visual input of operating parameters (meaning the train only goes as fast as it can stop within the locomotive operator's visual range). Thus, productivity would increase along with safety.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A locomotive control system, comprising:
a detection component, having a plurality of sensors configured to determine an operating condition for a plurality of locomotive operating systems, one or more forward looking imaging systems oriented to capture a live field of view along a track carrying the locomotive, a global positioning system (GPS) to determine a current position of the locomotive, and a geospatial information system providing geographic information for a designated track infrastructure to carry the locomotive, the detection component providing an input layer to a neural network; and
a locomotive manager configured to provide automated real time control inputs to the plurality of locomotive operating systems, responsive to an output of the neural network.

2. The locomotive control system of claim 1, the detection component further comprising:
a rail integrity monitoring system providing an integrity condition of the track in advance of the locomotive along the designated track infrastructure.

3. The locomotive control system of claim 1, wherein the detection component further comprises:
a crossing guard component, having one or more cameras providing a live image of a crossing grade for the designated track infrastructure.

4. The locomotive control system of claim 1, the detection component further comprising one or more of an engine health sensor; a turbo health senor; and a combined health sensor.

5. The locomotive control system of claim 1, the detection component further comprising:
a car integrity monitoring system.

6. The locomotive control system of claim 1, further comprising:
a display system to selectably display a plurality of viewing regions, wherein a selected information feed may be displayed within each of the plurality of viewing regions.

7. The locomotive control system of claim 6, wherein one of the plurality of viewing region comprises:
a synthesized view of the track ahead of the locomotive provided by one or more imaging systems.

8. The locomotive control system of claim 6, wherein one of the plurality of viewing region comprises:
a positive train control information display.

9. The locomotive control system of claim 6, wherein one of the plurality of viewing region comprises:
a live video feed of a crossing grade along the designated track.

10. The locomotive control system of claim 6, wherein one of the plurality of viewing region comprises:
an alert of an abnormal operating condition detected in one of the plurality of the locomotive operating system, wherein the alert includes a visual representation of the operating system and an indicator for an affected component.

11. The locomotive control system of claim 10, further comprising:
a companion viewing region, presenting a live video feed of an area corresponding to the affected operating system, wherein the alert and the companion viewing region are autonomously presented upon detection of the abnormal operating condition.

12. A digital locomotive cab, comprising:
a mobile computing device operatively connected to a communications network of the locomotive, the mobile computing device mounted to receive a touch screen input of an operator seated at an operator's seat of the locomotive cab,
a heads-up display system (HUD) configured to selectably project, on a windshield of the locomotive cab, a visual representation of: one or more operational parameters of the locomotive, an environmental condition of the exterior of the locomotive, and an augmented reality representation of a track carrying the locomotive; the visual representation discernable from the operator's seat of the locomotive cab.

13. The digital locomotive cab, of claim 12 wherein the visual representation further comprises:
a forward looking infra red (FLIR) image of the track ahead of the locomotive.

14. The digital locomotive cab of claim 12, wherein the visual representation further comprises:
a radar image of the track ahead of the locomotive.

15. The digital locomotive cab of claim 12, wherein the visual representation further comprises:
a route designation indicia representing a course of the track ahead of the locomotive.

16. The digital locomotive cab of claim 12, wherein the visual representation further comprises:
a prerecorded video image of the track ahead of the locomotive, corresponding to a current location of the locomotive on the track.

17. The digital locomotive cab of claim 12, further comprising:
a digital assistant operatively connected to the communications network, the digital assistant responsive to voice commands of the operator.

18. The digital locomotive cab of claim 17, wherein the digital assistant provides one or more of: an audio alert of an operating condition of the locomotive, a waypoint announcement; a communication of a track hazard.

19. The digital locomotive cab of claim of claim 18, wherein the digital assistant provides an audio communication channel with an operations center.
